(19) United States
(12) Patent Application Publication
(10) Pub. No.: US 2025/0307334 A1
(43) Pub. Date: Oct. 2, 2025

(54) METHODS, SYSTEMS, ARTICLES OF MANUFACTURE AND APPARATUS TO MANAGE PRIVACY WITH A SHARED CACHE

(71) Applicants: Michael David McCool, Edmundston (CA); Geoffrey Gustafson, Saint Johns, FL (US); Sudeep Divakaran, Bangalore (IN); Muthaiah Venkatachalam, Beaverton, OR (US)

(72) Inventors: Michael David McCool, Edmundston (CA); Geoffrey Gustafson, Saint Johns, FL (US); Sudeep Divakaran, Bangalore (IN); Muthaiah Venkatachalam, Beaverton, OR (US)

(21) Appl. No.: 19/233,963

(22) Filed: Jun. 10, 2025

(30) Foreign Application Priority Data
Jun. 10, 2024 (IN) 202441044638

(51) Int. Cl. G06F 16/957; G06F 12/084

(52) U.S. Cl. CPC G06F 16/9574; G06F 12/084

(57) ABSTRACT

This disclosure relates generally to shared caches and, more particularly, to methods, systems, articles of manufacture, and apparatus to manage privacy with a shared cache in the context of networked systems running untrusted code, such as web browsers. An example apparatus comprises machine-readable instructions, and at least one processor circuit to be programmed by the machine-readable instructions to determine if a machine learning model is located in a shared cache of a web browser, determine an activity state of a client application, and when the activity state of the client application is inactive and the machine learning model is located in the shared cache of the web browser, cause a simulated model download before the client application is notified of an availability of the machine learning model in the shared cache of the web browser.

### RELATED APPLICATIONS

This patent arises from the national stage of International Application No. 202441044638, which was filed on Jun. 10, 2024. International Application No. 202441044638 is hereby incorporated herein by reference in its entirety. Priority to International Application No. 202441044638 is hereby claimed.

### BACKGROUND

In recent years, online privacy has become a priority for entities that operate in any networked environment. Storage partitioning is acceptable with pre-artificial intelligence (AI) content because large resources such as images are generally not shared across sites, whereas resources that were shared, such as script libraries, tend to be relatively small. Machine learning models are both large and shared, therefore storage partitioning is no longer an acceptable solution.

### BRIEF DESCRIPTION OF THE DRAWINGS

FIG. 1 is a block diagram of an example environment to manage privacy with a shared cache.

FIG. 2 (represented by FIGS. 2A, 2B, and 2C) is a flowchart of an example process that may be implemented by the example environment of FIG. 1 to manage privacy with a shared cache.

FIG. 3 is a block diagram of an example processing platform including programmable circuitry structured to execute, instantiate, and/or perform the example machine readable instructions and/or perform the example operations of FIG. 2 to implement the environment of FIG. 1.

FIG. 4 is a block diagram of an example implementation of the programmable circuitry of FIG. 3.

FIG. 5 is a block diagram of another example implementation of the programmable circuitry of FIG. 3.

FIG. 6 is a block diagram of an example software/firmware/instructions distribution platform (e.g., one or more servers) to distribute software, instructions, and/or firmware (e.g., corresponding to the example machine readable instructions of FIG. 2) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Generally, web platforms implemented in web browsers follow a storage partitioning approach where data from different origins is strictly separated. For example, since 2020, the Chrome® browser (and other browsers) have used a same-origin policy for all resources in a Hypertext Transfer Protocol (HTTP) cache, and the same policy is followed for other storage application programming interfaces (APIs) (e.g., a Service Worker Cache API). Content Distribution Networks (CDNs) also follow this policy in some examples. This policy approach is intended to avoid a timing attack where Site A can check if a certain resource used by Site B is in the cache by checking the latency needed to load it. If a resource characteristic of Site B can be identified as being resident in the cache, such as an image of a logo, then Site A can infer that Site B was visited by the user (e.g., recently). In some circumstances, there is a possibility that tracking data between sites could be achieved by polluting a shared cache with “markers” and then checking for their existence when visited via another origin.

Generally speaking, such timing attacks are difficult to mitigate because the purpose of a cache is to, in part, reduce latency, and the timing attack measures this reduction. Storage partitioning is acceptable with pre-artificial intelligence (AI) content because it was empirically determined that large resources such as images are generally not shared across sites, whereas resources that were shared, such as script libraries, tend to be relatively small. For this kind of content (images and scripts), the bandwidth and storage overhead of storage partitioning has been deemed acceptable to reduce privacy risk.

However, AI models (e.g., machine learning models) are both large, like images, and shared, like script libraries. Storage partitioning is no longer an acceptable solution. However, maintaining user privacy remains a web platform priority. A mechanism is needed to provide the benefits of a shared cross-site cache for AI models while mitigating the privacy risks.

As noted, storage partitioning (in particular, partitioning caches by origin) does not solve the problem of cross-site sharing of AI models. Per-origin caches can, however, reduce the latency of subsequent loads by the same site. It should also be noted that other forms of caching, such as caching for compiled shaders in graphics APIs, can suffer from the same privacy issue if shared cross-origin. In general, if storage partitioning is used, wasteful redundant bandwidth (e.g., for downloading the model again) and computation (for compilation) must be used.

Examples disclosed herein mitigate one or more negative impacts of model (e.g., artificial intelligence (AI) models, machine learning (ML) models, etc.) download and storage in a context of web applications. Examples disclosed herein cooperate with and/or otherwise augment proposed and existing standards, such as, but not limited to the World Wide Web Consortium (W3C) Web Neural Network (WebNN) standard. Examples disclosed herein manage privacy and implement techniques to avoid leaking information across sites from different origins when using a shared cache.

In some examples, storage overhead is mitigated for redundant items in the cache using deduplication, even under storage partitioning. In addition, examples disclosed herein build upon a proposed web platform API, “Background Model Load”, which manages large downloads while the site requesting the download is inactive.

In some examples, cross-site caching is used while ensuring privacy if the risk of detecting the presence of a previously downloaded item in the cache is eliminated. In some examples, the delay of the cache miss is emulated when necessary, but with a simulated background “model activation” process that can only progress when the requesting page is inactive, so that other metrics cannot be used to detect the lack of an actual download.

Cross-site caching has at least four benefits: 1) elimination of redundant storage, 2) elimination of redundant downloads (network traffic, which for models may be on the order of gigabytes (GBs) of data), 3) elimination of redundant computation for compilation and optimization of models for specific execution mechanisms, and 4) reduction of latency for models (or parts of models) already in the cache.

It is possible to eliminate redundant storage by using deduplication, but deduplication does not provide the other benefits mentioned. Examples disclosed herein also eliminate redundant storage (and hash-based keying can also be used to ensure that duplicates that are downloaded from different origins are still identified).

Of these benefits, reduction in latency is the most difficult to achieve. Examples disclosed herein include a user override (e.g., via a user interface provided by the browser but hidden from the web application) to “expedite” the “activation” of a model (e.g., avoiding the download and compilation time of a model by making a previously downloaded and compiled model available) for the current page. The user would have to make the choice to trust the current site because expediting an activation would reveal the presence of a model in the cache downloaded by a different origin. However, this is, in most cases, a lower privacy risk than using an alternative such as a cloud-based model service. The user could choose instead to wait (e.g., incurring latency) until an emulated download timer has expired. However, in this case privacy, bandwidth, and storage will all still be preserved. The use of an emulated download timer will be referred to as a “fake miss” or “simulated model download” in the following. It is designed so that a web application cannot use timing to determine if an item is already in the cache or not.

As with the existing “Background Fetch” feature already supported by Chrome and Edge, a user interface would make pending model activations visible. In some examples, this approach is referred to as “Background Model Load” to distinguish it, since it would manipulate a distinct model cache, and would have slightly different behavior than “Background Fetch” to support cross-site sharing.

In some examples, the user can see which models are already in the cache and which model activations can therefore be expedited, and which cannot. In some examples, the user can also see which models are pending activation or are currently being downloaded and compiled. In some examples, this information is only made available to the user via the user interface, not to any web application code. This user interface also mitigates the use of the shared cache for tracking, especially when combined with a hash-based keying scheme, which only allows one bit to be transmitted between sites by checking for model existence. Through the information exposed through the user interface, a suspicious site trying to populate the model cache with many fake models for tracking purposes would be immediately obvious. The user interface would also allow for the cancellation of Background Model Loads to address this situation.

Other privacy mitigations might be used as well to layer defenses, for example by not providing the “Background Model Load” API to third-party content (e.g. advertisements embedded in web pages) by default.

Every item (e.g., model or partial model; in general the term “item” will be understood to mean this in the following) in the model cache would maintain metadata consisting of a list of origins that have “activated” it. This means either that origin was the first to download and compile that item directly through the Web Neural Network (WebNN) API, through another API, or a page from the origin has initiated and completed the activation process for that item, including if necessary the (undetectable to the application) fake miss (e.g., simulated model download) process described below, or the user has explicitly expedited activation of an item that for which a fake miss was in progress.

If the target item is not in the cache, it would be queued for actual background download and compilation. Note that to avoid detection of “fake misses”, this process should only proceed when the requesting page is inactive (e.g., not in an active state where code can be executed). However, the browser, as an optional feature, could open a user interface, such as a popup, that would allow the process to proceed immediately, concurrent with the application, at a small risk to privacy—the site would only be able to infer that the target item had NOT been loaded before. It may be possible, via user settings in the browser, to also make this the default behavior, or to allow a model download and compilation to proceed even when the requesting site is active (incurring a small privacy risk), or to bypass the fake miss process in some circumstances, such as built-in models (whose existence can already be inferred from the browser version) or very small models (when duplicate download cost is not an issue).

If the target item is in the cache, and was previously activated under the current origin, then it can be loaded from the cache and used immediately. This can be done even if the item was flushed from the cache and reloaded by a different origin since. Metadata recording activations should therefore be made persistent as much as possible to avoid the need for redundant activations for the same origin.

If the item is in the cache, but was not activated by the current origin, then the browser needs to emulate the download and compilation process undetectably to the requesting web application, but while avoiding bandwidth and computer resource consumption. As mentioned above, we call this a “fake miss”. First, the item would be queued for “Background Model Load” as if it needed download and compilation. However, since the item has already been fetched and compiled, the system does not actually need to do the download or compilation, but to avoid the privacy risk of a timing attack it has to emulate the latency of these operations by simply waiting an appropriate amount of time (e.g. the same as the time of the initial activation time, modulated by some random value) before the activation completion can be communicated to the requesting web application. There is a (small) risk that the code running in the page fetched from the new origin could monitor system metrics such as CPU and network performance using, for example, micro-benchmarks, and could use these metrics to determine that download and compilation was not, in fact, taking place. This risk can be (e.g., optionally) mitigated by only allowing the timer for the activation to progress when the pages loaded from the new origin are not active. Inactivation of code from origins that are not in use is a standard feature of web browsers. Note that to mitigate this risk all code originating from an origin needs to be inactivated, including any Workers.

In some examples, a user would be able to use a user interface for the “Background Model Load” at any time (e.g., even when the browser is closed) to “expedite” the activation of an item already in the model cache. This would make the model immediately available to the requesting application but however would also make it apparent that the item was already in the cache. It would be up to the user to decide if this privacy risk was appropriate for each given site requesting the model. Expediting a model for one origin would not automatically expedite it for any other origin. However, in some examples, a browser might provide a control to automatically expedite all models or expedite certain models for all origins (e.g. very common ones which would provide little information about which specific sites had been visited) or expedite models that might be requested from certain trusted sites. The user interface to control Background Model Load may be combined with the user interface for Background Fetch.

This approach can be used with or without hash-based cache keying. In hash-based keying, items in the cache are identified by hash values computed deterministically from their content to provide a cryptographically unique and content-dependent identifier for use as a key rather than using URLs or arbitrary user-defined identifier as a key. However, if Uniform Resource Locator (URL) based keys or arbitrary user-defined keys are allowed for a cross-site cache, other risks may be present, such as using a fake or modified model for a “mega cookie” to exfiltrate data from one site to another, or to embed tracking information in the cache using only presence or absence of specific items. While the user interface (UI) proposed here makes background activations visible, it itself should not be the only line of defense and does not protect from the use of modified models (which hash-based keying would protect against) to exfiltrate data from one origin to another, for example. Other mitigations may also be present, such as disallowing the use of the proposed Background Model Load API in third-party content. However, the most secure instantiation of this concept is in combination with a hash-keyed cache where the keys depend on the content directly. This way at best one bit per model can be communicated between origins or used as a fingerprint, and the number of such bits can be bound by limiting the number of items an origin can maintain in the model cache or limiting the rate or number of times that an application can check the cache. Note also that a cache check can transparently fail (e.g., return false even if the item is in the cache) once such a limit is exceeded without impacting application functionality.

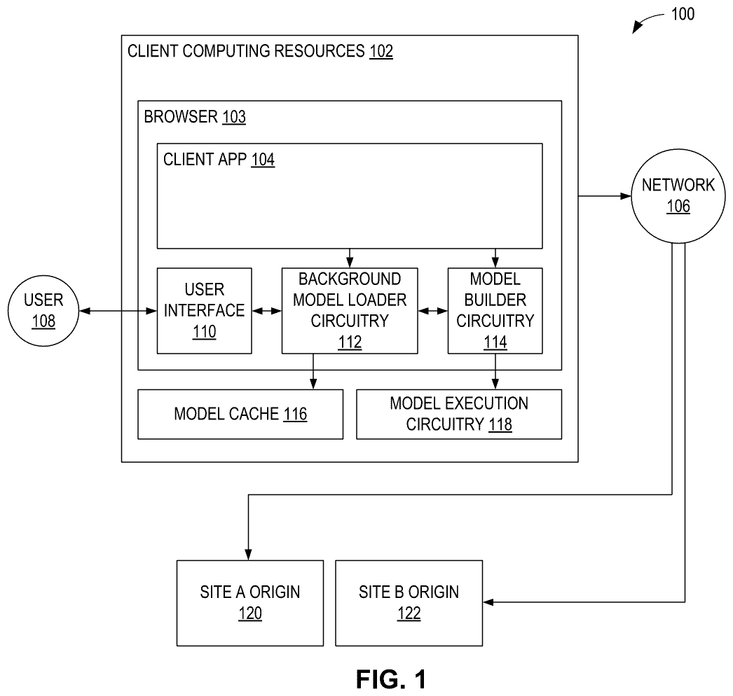

FIG. 1 is an illustration of an example environment 100 to manage privacy with a shared cache. In the illustrated example of FIG. 1, the environment 100 includes example client computing resources 102, an example browser 103, an example client application 104, and an example user interface 110 communicatively connected to a user 108. The example environment 100 includes example background model loader circuitry 112, example model builder circuitry 114, example model cache 116, example model execution circuitry 118, and the example client computing resources 102 are communicatively connected to one or more sites/origins via one or more example networks 106. In the illustrated example of FIG. 1, site A origin 120 and site B origin 122 are communicatively connected to the client computing resources 102 via the network(s) 106.

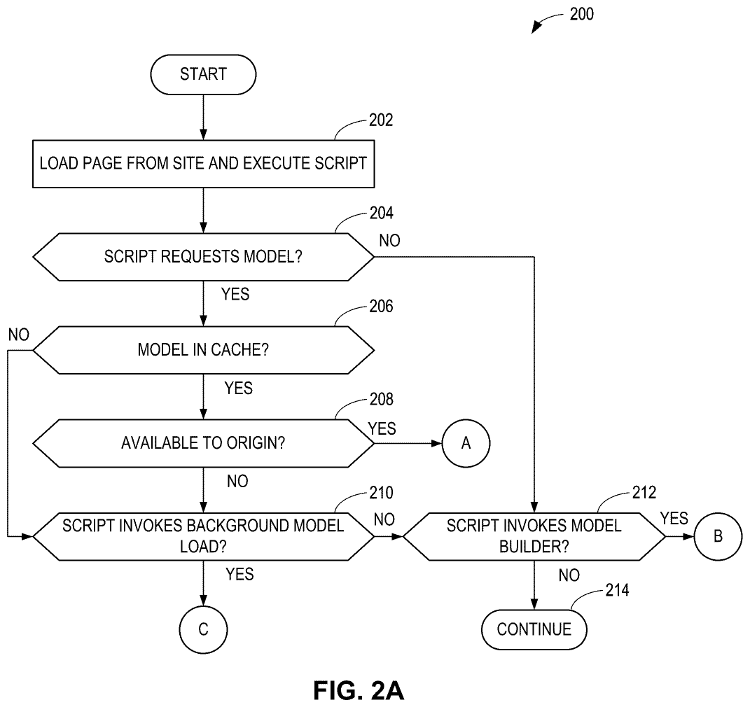

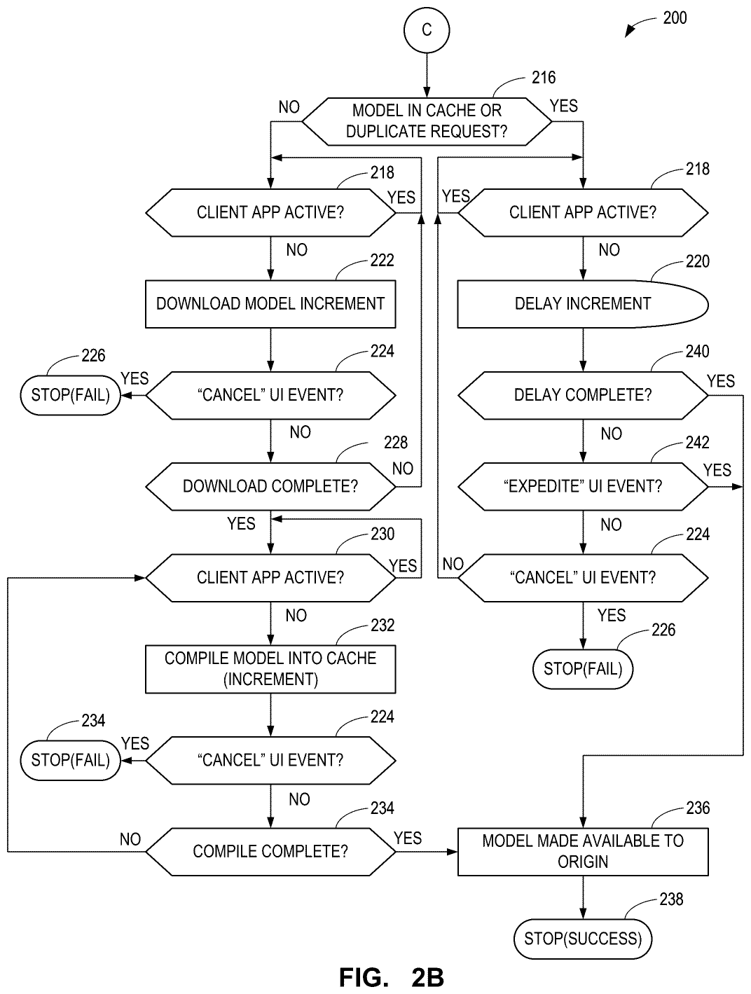

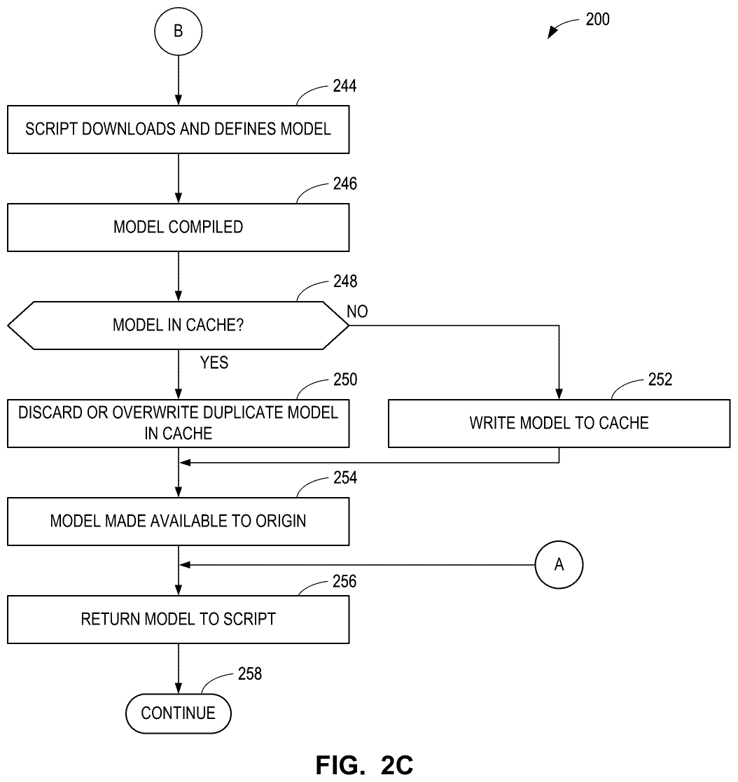

The environment 100 of FIG. 1 operates in a manner consistent with the example process 200 of FIG. 2. FIG. 2 (represented in FIGS. 2A, 2B, and 2C) is a flowchart of the example process 200 that may be implemented by the example environment 100 of FIG. 1 to manage privacy with a shared cache. In the illustrated example of FIG. 2, the browser loads a page from a site (which has an associated origin) and executes a script within that page (block 202), and the script then requests a model (block 204) by using an API to check if the model is already in the cache (e.g., present or absent from the cache). At block 206 the script may or may not check the cache for a given model. If it does, the process proceeds to block 208. In some examples, blocks 206 and 208 are combined and the independent results are not available to the script. The script should not be able to determine whether a model unavailable to it exists in the cache. If either test fails, then control proceeds to block 210. If the model is not in the cache (block 206) or in the cache but not available to the origin (block 208) the script was loaded from (e.g., these two cases are intentionally indistinguishable to the script), the script can then invoke the background model load process (block 210) through an API. If the model is in cache and available to the origin (blocks 206, 208) control proceeds to block 256. Further, if the script does not invoke the background model load process (block 210) control proceeds to block 212. Because the example background model load process can be instantiated in view of other conditions, for example, it might be invoked if the model is in the cache but is unavailable to the requesting origin, the background model loader circuitry 112 checks again whether the model is stored in the shared cache (block 216). Further, at block 216 the model loader circuitry 112 checks for a duplicate request. A duplicate request occurs if another script (from a different origin) has already requested the same model but the download and compilation is not complete. In either case, then the background model loader circuitry 112 waits until the client app requesting the model is dormant and/or otherwise not active (block 218).

As used herein, “client app” refers to all the code run on the client side that has downloaded from the origin and run on behalf of that origin to support the functions of a particular web site. To support privacy on the web, client apps from different origins are generally prohibited from sharing information or being able to monitor the activity of client apps from other origins, cannot access general system functions or data other than functions or data provided specifically by web standards, and any storage is also kept separate (principle of storage partitioning).

When the client app is not active (block 218), the model is not in the cache, and there is not a duplicate request (block 216), the background model loader circuitry 112 causes and/or otherwise permits a model download task to begin (block 222) and monitors for its completion (block 228). Further, the background model loader circuitry 112 determines if a cancel event has been initiated via the UI 110 (block 224) after the download has been permitted. For example, the user 108 may have knowledge that the client app is malicious and/or otherwise not desired and initiate the cancel event to stop (e.g., reject) further client app access (block 226). If the download is not complete, then control returns to block 218 to make sure that the client app is still inactive before permitting continued download attempts (block 222). However, when the download is complete (block 228), the client app is again monitored for its activity status (block 230). After the model is downloaded a following process is to compile the model. If the model is immediately compiled after the download has completed, there remains a possibility that the client app can detect such activities, which would further allow the client app to infer and/or otherwise gain knowledge of one or more behaviors of the client computing resources or to distinguish between a simulated model download and an actual model download and compilation. 102. To preserve privacy, the model is compiled (block 232) only after it has been determined that the client app is not active (block 230). The example background model loader circuitry 112 monitors for compilation completion (block 234) and, when complete, makes the model available to the origin (block 236). The process 200 of FIG. 2 then stops and/or otherwise completes (block 238). Note that this does not return the model directly the invoking script. Instead the model is simply placed in the cache and marked as available for the invoking script's origin, so the next time the checks for model availability are performed by the same origin they will succeed.

Returning to block 216, if the model is already in the shared cache, or a duplicate request exists, then the background model loader circuitry 112 also determines if the client app is active (block 218). If so, the process 200 of FIG. 2 waits for the client app to become inactive before initiating a delay period (block 220) (e.g., for a total elapsed time similar to the time that would have been required for the actual or initial download and compilation of that model). This delay period can be referred to as a “fake miss” or “simulated model download” to make any attempted observers of the client computing resources 102 to believe and/or otherwise infer that time is being spent to download the model, even though the model is already stored in the shared cache. More specifically, measurements from within a script should be unable to distinguish between an actual download and compilation process and this “fake miss” or “simulated model download”. As such, even if the user 108 and/or browser 103 of the client computing resources 102 has already visited one or more sites, by implementing the delay period even when content (e.g., models, images) from those one or more sites is already in the shared cache, the origin(s) and/or other sites cannot confidently confirm prior activity (e.g., activity state) of the client computing resources with those other sites/origin(s), thereby preserving privacy.

If the delay is not complete (block 240), the user 108 has the option of skipping the delay with an expedite event/request via the user interface 110 (block 242). For example, the user 108 may have a degree of trust and/or confidence that the client app is safe and/or otherwise not a threat to privacy and initiate the expedite event. If so, then the model is immediately made available to the origin (block 236) (e.g., in response to the expedite event). If the expedite event has not been selected (block 226), the background model loader circuitry 112 determines if a cancel event has been initiated via the UI 110 (block 224). For example, the user 108 may have knowledge that the client app is malicious and/or otherwise not desired and initiate the cancel event to stop (e.g., reject) further client app access (block 226).

Returning to block 212 the background model load circuitry 112 determines whether the script invokes a model builder. If it is determined that the script invokes a model builder in block 212 control proceeds to block 244. At block 244 the browser downloads and defines the model. At block 246 the model is compiled before control is proceeded to block 248. A script may also not invoke the model builder at all and continue other processing in block 214. In such an example, the script may use an alternative approach to achieve the same functionality, for example by accessing a remote service.

At block 248 it is determined whether the same model is already in the cache. If the model is in cache control proceeds to block 250 where the background model load circuitry 112 discards or overwrites the duplicate model in cache. Alternatively, control proceeds to block 252 where the background model load circuitry 112 writes the new model to cache.

At block 254 the model is made available to the origin. Further at block 256 the model is returned to the script before proceeding to block 258, where the script may continue execution, including use of the model. Since the process defined in blocks 244 through 256 may take some time, they may be performed asynchronously in whole or in part while the script performs other tasks, and block 258 would then signal completion of the process with an event or a resolution of a promise. Note that upon continuation of the script in block 258 the script has access to the model, while after block 214 it does not.

While an example manner of implementing the environment 100 of FIG. 1 is illustrated in FIG. 2, one or more of the elements, processes, and/or devices illustrated in FIG. 1 may be combined, divided, re-arranged, omitted, eliminated, and/or implemented in any other way. Further, the structure, and/or, more generally, the example environment 100 of FIG. 1, may be implemented by hardware alone or by hardware in combination with software and/or firmware. Thus, for example, any of the structure/hardware/firmware/software, and/or, more generally, the example environment 100, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), neural processing units (NPUs), and/or field programmable logic device(s) (FPLD(s)) such as FPGAs in combination with machine readable instructions (e.g., firmware or software). Further still, the example environment 100 of FIG. 1 may include one or more elements, processes, and/or devices in addition to, or instead of, those illustrated in FIG. 1, and/or may include more than one of any or all of the illustrated elements, processes and devices.

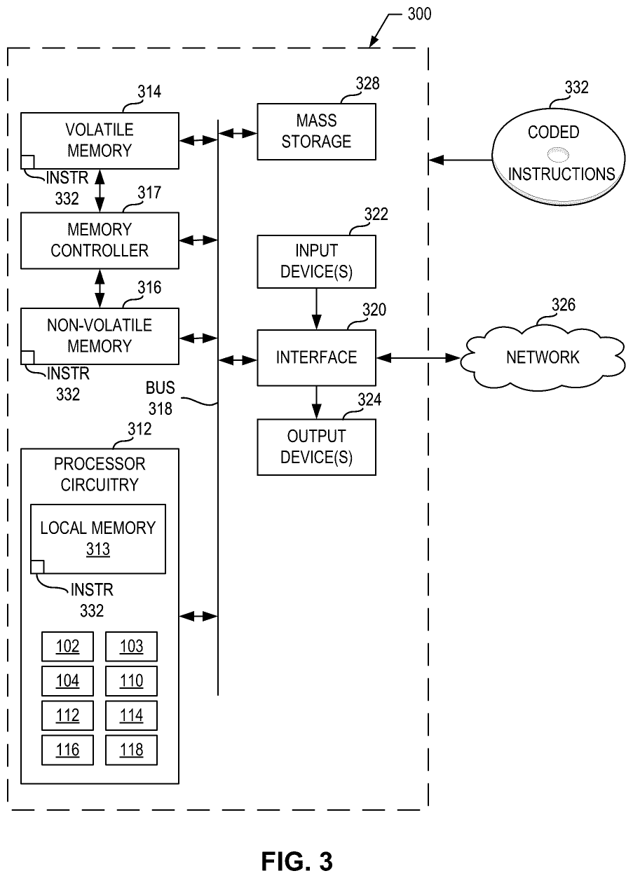

Flowchart(s) representative of example machine readable instructions, which may be executed by programmable circuitry to implement and/or instantiate the environment 100 of FIG. 1 and/or representative of example operations which may be performed by programmable circuitry to implement and/or instantiate the environment 100 of FIG. 1, are shown in FIGS. 2. The machine readable instructions may be one or more executable programs or portion(s) of one or more executable programs for execution by programmable circuitry such as the programmable circuitry 312 shown in the example processor platform 300 discussed below in connection with FIG. 3. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 2, many other methods of implementing the example environment 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, an NPU, and/or an FPGA. The programmable circuitry may include one or more CPUs, one or more GPUs, one or more VPUs, one or more NPUs, and/or one or more FPGAs located in the same package (e.g., the same integrated circuit (IC) package or in two or more separate housings), one or more CPUs, GPUs, VPUs, NPUs, and/or one or more FPGAs in a single machine, multiple CPUs, GPUs, VPUs, NPUs, and/or FPGAs distributed across multiple servers of a server rack, and/or multiple CPUs, GPUs, VPUs, NPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 2 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a block diagram of an example programmable circuitry platform 300 structured to execute and/or instantiate the example machine-readable instructions and/or the example operations of FIG. 2 to implement the environment 100 of FIG. 1. The programmable circuitry platform 300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 300 of the illustrated example includes programmable circuitry 312. The programmable circuitry 312 of the illustrated example is hardware. For example, the programmable circuitry 312 can be implemented by one or more integrated circuits, logic circuits, FPGAs, microprocessors, CPUs, GPUs, VPUs, DSPs, and/or microcontrollers from any desired family or manufacturer. The programmable circuitry 312 may be implemented by one or more semiconductor based (e.g., silicon based) devices.

The programmable circuitry 312 of the illustrated example includes a local memory 313 (e.g., a cache, registers, etc.). The programmable circuitry 312 of the illustrated example is in communication with main memory 314, 4316, which includes a volatile memory 314 and a non-volatile memory 316, by a bus 318. The volatile memory 314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 316 may be implemented by flash memory and/or any other desired type of memory device. Access to the main memory 314, 316 of the illustrated example is controlled by a memory controller 317. In some examples, the memory controller 317 may be implemented by one or more integrated circuits, logic circuits, microcontrollers from any desired family or manufacturer, or any other type of circuitry to manage the flow of data going to and from the main memory 314, 316.

The programmable circuitry platform 300 of the illustrated example also includes interface circuitry 320. The interface circuitry 320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 322 are connected to the interface circuitry 320. The input device(s) 322 permit(s) a user (e.g., a human user, a machine user, etc.) to enter data and/or commands into the programmable circuitry 312. The input device(s) 322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 324 are also connected to the interface circuitry 320 of the illustrated example. The output device(s) 324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, an eInk display, etc.), a tactile output device, a printer, and/or speaker. The interface circuitry 320 of the illustrated example, thus, typically includes a graphics driver card, a graphics driver chip, and/or graphics processor circuitry such as a GPU.

The interface circuitry 320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 300 of the illustrated example also includes one or more mass storage discs or devices 328 to store firmware, software, and/or data. Examples of such mass storage discs or devices 328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 332, which may be implemented by the machine readable instructions of FIG. 2, may be stored in the mass storage device 328, in the volatile memory 314, in the non-volatile memory 316, and/or on at least one non-transitory computer readable storage medium such as a CD or DVD which may be removable.

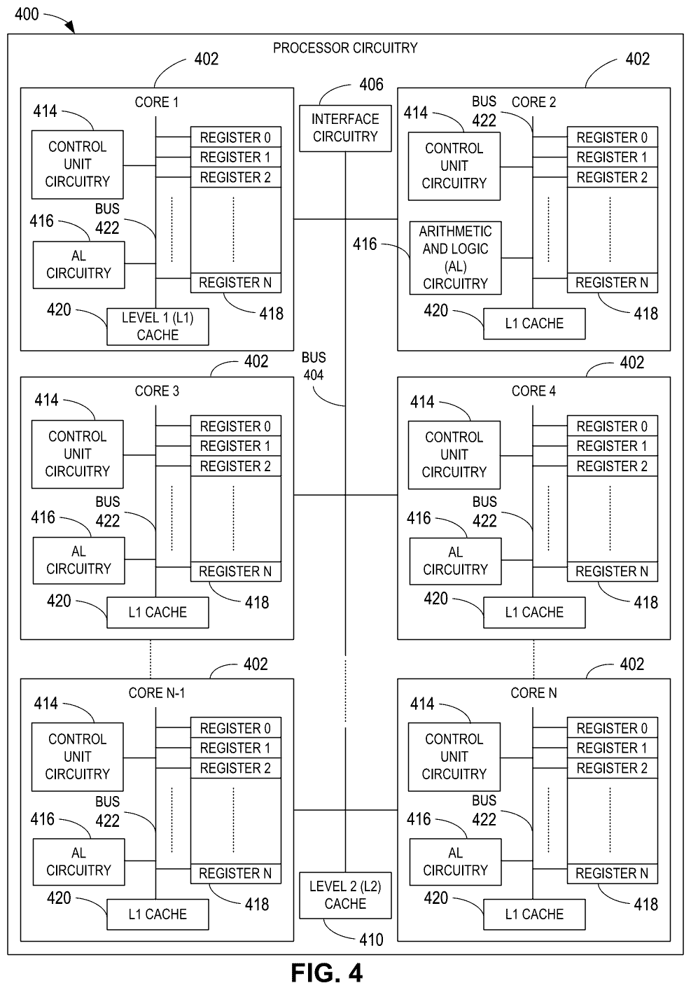

FIG. 4 is a block diagram of an example implementation of the programmable circuitry 312 of FIG. 3. In this example, the programmable circuitry 312 of FIG. 3 is implemented by a microprocessor 400. For example, the microprocessor 400 may be a general-purpose microprocessor (e.g., general-purpose microprocessor circuitry). The microprocessor 400 executes some or all of the machine-readable instructions of the flowcharts of FIG. 2 to effectively instantiate the circuitry of FIG. 1 as logic circuits to perform operations corresponding to those machine readable instructions. In some such examples, the circuitry of FIG. 1 is instantiated by the hardware circuits of the microprocessor 400 in combination with the machine-readable instructions. For example, the microprocessor 400 may be implemented by multi-core hardware circuitry such as a CPU, a DSP, a GPU, an XPU, etc. Although it may include any number of example cores 402 (e.g., 1 core), the microprocessor 400 of this example is a multi-core semiconductor device including N cores. The cores 402 of the microprocessor 400 may operate independently or may cooperate to execute machine readable instructions. For example, machine code corresponding to a firmware program, an embedded software program, or a software program may be executed by one of the cores 402 or may be executed by multiple ones of the cores 402 at the same or different times. In some examples, the machine code corresponding to the firmware program, the embedded software program, or the software program is split into threads and executed in parallel by two or more of the cores 402. The software program may correspond to a portion or all of the machine readable instructions and/or operations represented by the flowcharts of FIG. 2.

The cores 402 may communicate by a first example bus 404. In some examples, the first bus 404 may be implemented by a communication bus to effectuate communication associated with one(s) of the cores 402. For example, the first bus 404 may be implemented by at least one of an Inter-Integrated Circuit (I2C) bus, a Serial Peripheral Interface (SPI) bus, a PCI bus, or a PCIe bus. Additionally or alternatively, the first bus 404 may be implemented by any other type of computing or electrical bus. The cores 402 may obtain data, instructions, and/or signals from one or more external devices by example interface circuitry 406. The cores 402 may output data, instructions, and/or signals to the one or more external devices by the interface circuitry 406. Although the cores 402 of this example include example local memory 420 (e.g., Level 1 (L1) cache that may be split into an L1 data cache and an L1 instruction cache), the microprocessor 400 also includes example shared memory 410 that may be shared by the cores (e.g., Level 2 (L2 cache)) for high-speed access to data and/or instructions. Data and/or instructions may be transferred (e.g., shared) by writing to and/or reading from the shared memory 410. The local memory 420 of each of the cores 402 and the shared memory 410 may be part of a hierarchy of storage devices including multiple levels of cache memory and the main memory (e.g., the main memory 314, 316 of FIG. 3). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 402 may be referred to as a CPU, DSP, GPU, etc., or any other type of hardware circuitry. Each core 402 includes control unit circuitry 414, arithmetic and logic (AL) circuitry (sometimes referred to as an ALU) 416, a plurality of registers 418, the local memory 420, and a second example bus 422. Other structures may be present. For example, each core 402 may include vector unit circuitry, single instruction multiple data (SIMD) unit circuitry, load/store unit (LSU) circuitry, branch/jump unit circuitry, floating-point unit (FPU) circuitry, etc. The control unit circuitry 414 includes semiconductor-based circuits structured to control (e.g., coordinate) data movement within the corresponding core 402. The AL circuitry 416 includes semiconductor-based circuits structured to perform one or more mathematic and/or logic operations on the data within the corresponding core 402. The AL circuitry 416 of some examples performs integer based operations. In other examples, the AL circuitry 416 also performs floating-point operations. In yet other examples, the AL circuitry 416 may include first AL circuitry that performs integer-based operations and second AL circuitry that performs floating-point operations. In some examples, the AL circuitry 416 may be referred to as an Arithmetic Logic Unit (ALU).

The registers 418 are semiconductor-based structures to store data and/or instructions such as results of one or more of the operations performed by the AL circuitry 416 of the corresponding core 402. For example, the registers 418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 418 may be arranged in a bank as shown in FIG. 4. Alternatively, the registers 418 may be organized in any other arrangement, format, or structure, such as by being distributed throughout the core 402 to shorten access time. The second bus 422 may be implemented by at least one of an I2C bus, a SPI bus, a PCI bus, or a PCIe bus.

Each core 402 and/or, more generally, the microprocessor 400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 400 is a semiconductor device fabricated to include many transistors interconnected to implement the structures described above in one or more integrated circuits (ICs) contained in one or more packages.

The microprocessor 400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 400, in the same chip package as the microprocessor 400 and/or in one or more separate packages from the microprocessor 400.

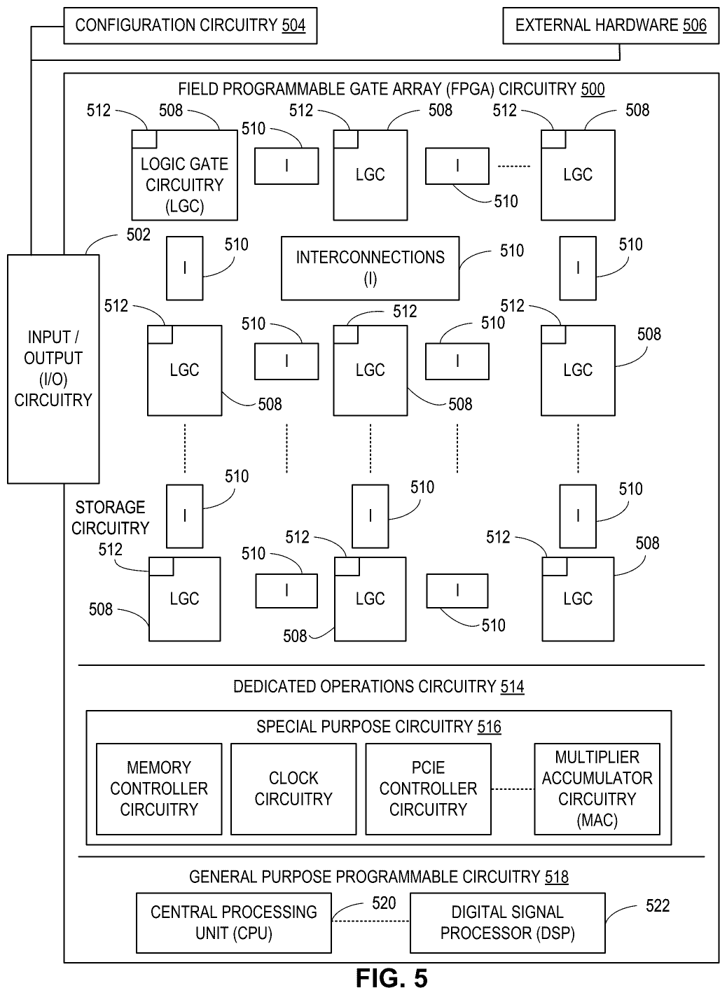

FIG. 5 is a block diagram of another example implementation of the programmable circuitry 312 of FIG. 3. In this example, the programmable circuitry 312 is implemented by FPGA circuitry 500. For example, the FPGA circuitry 500 may be implemented by an FPGA. The FPGA circuitry 500 can be used, for example, to perform operations that could otherwise be performed by the example microprocessor 400 of FIG. 4 executing corresponding machine readable instructions. However, once configured, the FPGA circuitry 500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 400 of FIG. 4 described above (which is a general purpose device that may be programmed to execute some or all of the machine readable instructions represented by the flowchart(s) of FIG. 2 but whose interconnections and logic circuitry are fixed once fabricated), the FPGA circuitry 500 of the example of FIG. 5 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 2. In particular, the FPGA circuitry 500 may be thought of as an array of logic gates, interconnections, and switches. The switches can be programmed to change how the logic gates are interconnected by the interconnections, effectively forming one or more dedicated logic circuits (unless and until the FPGA circuitry 500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 2. As such, the FPGA circuitry 500 may be configured and/or structured to effectively instantiate some or all of the operations/functions corresponding to the machine readable instructions of the flowchart(s) of FIG. 2 as dedicated logic circuits to perform the operations/functions corresponding to those software instructions in a dedicated manner analogous to an ASIC. Therefore, the FPGA circuitry 500 may perform the operations/functions corresponding to the some or all of the machine readable instructions of FIG. 2 faster than the general-purpose microprocessor can execute the same.

In the example of FIG. 5, the FPGA circuitry 500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 500 of FIG. 5 may access and/or load the binary file to cause the FPGA circuitry 500 of FIG. 5 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 500 of FIG. 5 to cause configuration and/or structuring of the FPGA circuitry 500 of FIG. 5, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 500 of FIG. 5 may access and/or load the binary file to cause the FPGA circuitry 500 of FIG. 5 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 500 of FIG. 5 to cause configuration and/or structuring of the FPGA circuitry 500 of FIG. 5, or portion(s) thereof.

The FPGA circuitry 500 of FIG. 5, includes example input/output (I/O) circuitry 502 to obtain and/or output data to/from example configuration circuitry 504 and/or external hardware 506. For example, the configuration circuitry 504 may be implemented by interface circuitry that may obtain a binary file, which may be implemented by a bit stream, data, and/or machine-readable instructions, to configure the FPGA circuitry 500, or portion(s) thereof. In some such examples, the configuration circuitry 504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 506 may be implemented by external hardware circuitry. For example, the external hardware 506 may be implemented by the microprocessor 400 of FIG. 4.

The FPGA circuitry 500 also includes an array of example logic gate circuitry 508, a plurality of example configurable interconnections 510, and example storage circuitry 512. The logic gate circuitry 508 and the configurable interconnections 510 are configurable to instantiate one or more operations/functions that may correspond to at least some of the machine readable instructions of FIG. 2 and/or other desired operations. The logic gate circuitry 508 shown in FIG. 5 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 508 to enable configuration of the electrical structures and/or the logic gates to form circuits to perform desired operations/functions. The logic gate circuitry 508 may include other electrical structures such as look-up tables (LUTs), registers (e.g., flip-flops or latches), multiplexers, etc.

The configurable interconnections 510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 508 to program desired logic circuits.

The storage circuitry 512 of the illustrated example is structured to store result(s) of the one or more of the operations performed by corresponding logic gates. The storage circuitry 512 may be implemented by registers or the like. In the illustrated example, the storage circuitry 512 is distributed amongst the logic gate circuitry 508 to facilitate access and increase execution speed.

The example FPGA circuitry 500 of FIG. 5 also includes example dedicated operations circuitry 514. In this example, the dedicated operations circuitry 514 includes special purpose circuitry 516 that may be invoked to implement commonly used functions to avoid the need to program those functions in the field. Examples of such special purpose circuitry 516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 500 may also include example general purpose programmable circuitry 518 such as an example CPU 520 and/or an example DSP 522. Other general purpose programmable circuitry 518 may additionally or alternatively be present such as a GPU, an XPU, etc., that can be programmed to perform other operations.

Although FIGS. 4 and 5 illustrate two example implementations of the programmable circuitry 312 of FIG. 3, many other approaches are contemplated. For example, FPGA circuitry may include an on-board CPU, such as one or more of the example CPU 520 of FIG. 4. Therefore, the programmable circuitry 312 of FIG. 3 may additionally be implemented by combining at least the example microprocessor 400 of FIG. 4 and the example FPGA circuitry 500 of FIG. 5. In some such hybrid examples, one or more cores 402 of FIG. 4 may execute a first portion of the machine readable instructions represented by the flowchart(s) of FIG. 2 to perform first operation(s)/function(s), the FPGA circuitry 500 of FIG. 5 may be configured and/or structured to perform second operation(s)/function(s) corresponding to a second portion of the machine readable instructions represented by the flowcharts of FIG. 2, and/or an ASIC may be configured and/or structured to perform third operation(s)/function(s) corresponding to a third portion of the machine readable instructions represented by the flowcharts of FIG. 2.

It should be understood that some or all of the circuitry of FIG. 1 may, thus, be instantiated at the same or different times. For example, same and/or different portion(s) of the microprocessor 400 of FIG. 4 may be programmed to execute portion(s) of machine-readable instructions at the same and/or different times. In some examples, same and/or different portion(s) of the FPGA circuitry 500 of FIG. 5 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 400 of FIG. 4 may execute machine readable instructions in one or more threads executing concurrently and/or in series. In some examples, the FPGA circuitry 500 of FIG. 5 may be configured and/or structured to carry out operations/functions concurrently and/or in series. Moreover, in some examples, some or all of the circuitry of FIG. 1 may be implemented within one or more virtual machines and/or containers executing on the microprocessor 400 of FIG. 4.

In some examples, the programmable circuitry 312 of FIG. 3 may be in one or more packages. For example, the microprocessor 400 of FIG. 4 and/or the FPGA circuitry 500 of FIG. 5 may be in one or more packages. In some examples, an XPU may be implemented by the programmable circuitry 312 of FIG. 3, which may be in one or more packages. For example, the XPU may include a CPU (e.g., the microprocessor 400 of FIG. 4, the CPU 520 of FIG. 5, etc.) in one package, a DSP (e.g., the DSP 522 of FIG. 5) in another package, a GPU in yet another package, and an FPGA (e.g., the FPGA circuitry 500 of FIG. 5) in still yet another package.

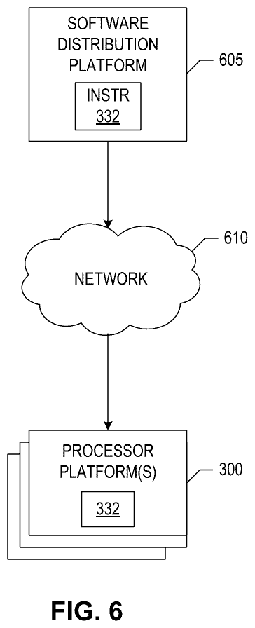

A block diagram illustrating an example software distribution platform 605 to distribute software such as the example machine readable instructions 332 of FIG. 3 to other hardware devices (e.g., hardware devices owned and/or operated by third parties from the owner and/or operator of the software distribution platform) is illustrated in FIG. 6. The example software distribution platform 605 may be implemented by any computer server, data facility, cloud service, etc., capable of storing and transmitting software to other computing devices. The third parties may be customers of the entity owning and/or operating the software distribution platform 605. For example, the entity that owns and/or operates the software distribution platform 605 may be a developer, a seller, and/or a licensor of software such as the example machine readable instructions 332 of FIG. 3. The third parties may be consumers, users, retailers, OEMs, etc., who purchase and/or license the software for use and/or re-sale and/or sub-licensing. In the illustrated example, the software distribution platform 605 includes one or more servers and one or more storage devices. The storage devices store the machine readable instructions 332, which may correspond to the example machine readable instructions of FIG. 2, as described above. The one or more servers of the example software distribution platform 605 are in communication with an example network 610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 332 from the software distribution platform 605. For example, the software, which may correspond to the example machine readable instructions of FIG. 2, may be downloaded to the example programmable circuitry platform 300, which is to execute the machine readable instructions 332 to implement the environment 100. In some examples, one or more servers of the software distribution platform 605 periodically offer, transmit, and/or force updates to the software (e.g., the example machine readable instructions 332 of FIG. 3) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units, Neural Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more Network Processing Units, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to manage privacy with a shared cache are disclosed herein. Further examples and combinations thereof include the following:
Example 1 includes an apparatus comprising machine-readable instructions, and at least one processor circuit to be programmed by the machine-readable instructions to determine if a machine learning model is located in a shared cache of a web browser, determine an activity state of a client application, and when the activity state of the client application is inactive and the machine learning model is located in the shared cache of the web browser, cause a simulated model download before the client application is notified of an availability of the machine learning model in the shared cache of the web browser.
Example 2 includes the apparatus as defined in example 1, wherein one or more of the at least one processor circuit is to, when the activity state of the client application is inactive and the machine learning model is absent from the shared cache of the web browser, cause the machine learning model to be downloaded to the shared cache of the web browser.
Example 3 includes the apparatus as defined in example 1, wherein one or more of the at least one processor circuit is to determine if an expedite event occurs during the simulated model download.
Example 4 includes the apparatus as defined in example 3, wherein one or more of the at least one processor circuit is to permit access to the machine learning model in response to the expedite event, the expedite event to cancel the simulated model download.
Example 5 includes the apparatus as defined in example 1, wherein one or more of the at least one processor circuit is to determine if a cancel event occurs during the simulated model download.
Example 6 includes the apparatus as defined in example 5, wherein one or more of the at least one processor circuit is to reject access to the machine learning model in response to the cancel event.
Example 7 includes the apparatus as defined in example 1, wherein a duration of the simulated model download is based on an initial download and compilation time of the machine learning model modulated by a random value.
Example 8 includes the apparatus as defined in example 1, wherein the client application is executed in the web browser.
Example 9 includes the apparatus as defined in example 1, wherein the one or more of the at least one processor circuit is to determine if the machine learning model is located in the shared cache of the web browser in response to a request by the client application to access the machine learning model.
Example 10 includes at least one non-transitory machine-readable medium comprising machine-readable instructions to cause at least one processor circuit to at least determine if a machine learning model is located in a shared cache of a web browser, determine an activity state of a client application, and when the activity state of the client application is inactive and the machine learning model is located in the shared cache of the web browser, cause a simulated model download before the client application is notified of an availability of the machine learning model in the shared cache of the web browser.
Example 11 includes the at least one non-transitory machine-readable medium of example 10, wherein the machine-readable instructions are to cause one or more of the at least one processor circuit to, when the activity state of the client application is inactive and the machine learning model is absent from the shared cache of the web browser, cause the machine learning model to be downloaded to the shared cache of the web browser.
Example 12 includes the at least one non-transitory machine-readable medium of example 10, wherein the machine-readable instructions are to cause one or more of the at least one processor circuit to determine if an expedite event occurs during the simulated model download.
Example 13 includes the at least one non-transitory machine-readable medium of example 12, wherein the machine-readable instructions are to cause one or more of the at least one processor circuit to permit access to the machine learning model in response to the expedite event, the expedite event to cancel the simulated model download.
Example 14 includes the at least one non-transitory machine-readable medium of example 10, wherein the machine-readable instructions are to cause one or more of the at least one processor circuit to determine if a cancel event occurs during the simulated model download.
Example 15 includes the at least one non-transitory machine-readable medium of example 14, wherein the machine-readable instructions are to cause one or more of the at least one processor circuit to reject access to the machine learning model in response to the cancel event.
Example 16 includes the at least one non-transitory machine-readable medium of example 10, wherein a duration of the simulated model download is based on an initial download and compilation time of the machine learning model modulated by a random value.
Example 17 includes a method comprising determining if a machine learning model is located in a shared cache of a web browser, determining an activity state of a client application, and when the activity state of the client application is inactive and the machine learning model is located in the shared cache of the web browser, causing a simulated model download before the client application is notified of an availability of the machine learning model in the shared cache of the web browser.
Example 18 includes the method of example 17, wherein when the activity state of the client application is inactive and the machine learning model is absent from the shared cache of the web browser, causing the machine learning model to be downloaded to the shared cache of the web browser.
Example 19 includes the method of example 17, further including determining if an expedite event occurs during the simulated model download.
Example 20 includes the method of example 19, further including permitting access to the machine learning model in response to the expedite event, the expedite event to cancel the simulated model download.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
machine-readable instructions; and
at least one processor circuit to be programmed by the machine-readable instructions to:
determine if a machine learning model is located in a shared cache of a web browser;
determine an activity state of a client application; and
when the activity state of the client application is inactive and the machine learning model is located in the shared cache of the web browser, cause a simulated model download before the client application is notified of an availability of the machine learning model in the shared cache of the web browser.

2. The apparatus as defined in claim 1, wherein one or more of the at least one processor circuit is to, when the activity state of the client application is inactive and the machine learning model is absent from the shared cache of the web browser, cause the machine learning model to be downloaded to the shared cache of the web browser.

3. The apparatus as defined in claim 1, wherein one or more of the at least one processor circuit is to determine if an expedite event occurs during the simulated model download.

4. The apparatus as defined in claim 3, wherein one or more of the at least one processor circuit is to permit access to the machine learning model in response to the expedite event, the expedite event to cancel the simulated model download.

5. The apparatus as defined in claim 1, wherein one or more of the at least one processor circuit is to determine if a cancel event occurs during the simulated model download.

6. The apparatus as defined in claim 5, wherein one or more of the at least one processor circuit is to reject access to the machine learning model in response to the cancel event.

7. The apparatus as defined in claim 1, wherein a duration of the simulated model download is based on an initial download and compilation time of the machine learning model modulated by a random value.

8. The apparatus as defined in claim 1, wherein the client application is executed in the web browser.

9. The apparatus as defined in claim 1, wherein the one or more of the at least one processor circuit is to determine if the machine learning model is located in the shared cache of the web browser in response to a request by the client application to access the machine learning model.

10. At least one non-transitory machine-readable medium comprising machine-readable instructions to cause at least one processor circuit to at least:
determine if a machine learning model is located in a shared cache of a web browser;
determine an activity state of a client application; and
when the activity state of the client application is inactive and the machine learning model is located in the shared cache of the web browser, cause a simulated model download before the client application is notified of an availability of the machine learning model in the shared cache of the web browser.

11. The at least one non-transitory machine-readable medium of claim 10, wherein the machine-readable instructions are to cause one or more of the at least one processor circuit to, when the activity state of the client application is inactive and the machine learning model is absent from the shared cache of the web browser, cause the machine learning model to be downloaded to the shared cache of the web browser.

12. The at least one non-transitory machine-readable medium of claim 10, wherein the machine-readable instructions are to cause one or more of the at least one processor circuit to determine if an expedite event occurs during the simulated model download.

13. The at least one non-transitory machine-readable medium of claim 12, wherein the machine-readable instructions are to cause one or more of the at least one processor circuit to permit access to the machine learning model in response to the expedite event, the expedite event to cancel the simulated model download.

14. The at least one non-transitory machine-readable medium of claim 10, wherein the machine-readable instructions are to cause one or more of the at least one processor circuit to determine if a cancel event occurs during the simulated model download.

15. The at least one non-transitory machine-readable medium of claim 14, wherein the machine-readable instructions are to cause one or more of the at least one processor circuit to reject access to the machine learning model in response to the cancel event.

16. The at least one non-transitory machine-readable medium of claim 10, wherein a duration of the simulated model download is based on an initial download and compilation time of the machine learning model modulated by a random value.

17. A method comprising:
determining if a machine learning model is located in a shared cache of a web browser;
determining an activity state of a client application; and
when the activity state of the client application is inactive and the machine learning model is located in the shared cache of the web browser, causing a simulated model download before the client application is notified of an availability of the machine learning model in the shared cache of the web browser.

18. The method of claim 17, wherein when the activity state of the client application is inactive and the machine learning model is absent from the shared cache of the web browser, causing the machine learning model to be downloaded to the shared cache of the web browser.

19. The method of claim 17, further including determining if an expedite event occurs during the simulated model download.

20. The method of claim 19, further including permitting access to the machine learning model in response to the expedite event, the expedite event to cancel the simulated model download.
